(19) United States
(12) Patent Application Publication
(10) Pub. No.: US 2024/0214667 A1
(43) Pub. Date: Jun. 27, 2024

(54) IMAGE-CAPTURING SYSTEM AND IMAGE-CAPTURING METHOD

(71) Applicant: GREATER SHINE LIMITED, Apia (WS)

(72) Inventors: YI-PIN CHANG, HSINCHU CITY (TW); CHIA-LUN TSAI, NEW TAIPEI CITY (TW)

(21) Appl. No.: 18/146,895

(22) Filed: Dec. 27, 2022

(51) Int. Cl. H04N 23/611; H04N 23/63; H04N 23/667; H04N 23/67

(52) U.S. Cl. CPC H04N 23/611; H04N 23/633; H04N 23/667; H04N 23/675

(57) ABSTRACT

The present disclosure provides an image-capturing system and an image-capturing method. The image-capturing system includes a first image-sensing module, a second image-sensing module, a display panel, and at least one processor. The display panel displays a preview image sensed by the first image-sensing module. The at least one processor detects objects in the preview image, detects a gaze region on the display panel at which a user is gazing according to gaze data acquired by the second image-sensing module, selects a target from the detected objects according to the gaze region, controls the first image-sensing module to perform a focusing operation with respect to the target, detects a blink mode of the user according to blink data acquired by the second image-sensing module, and performs a camera function according to the detected blink mode with the target being in focus.

### TECHNICAL FIELD

The present disclosure relates to an image-capturing system, and more particularly, to an image-capturing system allowing eye-blink control.

### DISCUSSION OF THE BACKGROUND

Autofocus is a common function that allows a digital camera in an electronic device to automatically focus on a region that has particular objects or details in a preview image. However, if the region selected by the electronic device does not meet a user's expectation, the user needs to manually select a focus region. For example, the electronic device may allow the user to touch a point on a display touch panel of the electronic device to indicate a region that the user would like to focus on so that the camera in the electronic device can adjust the focus region accordingly.

However, such a touch focus function requires complex manual operations that may shake the electronic device. For example, the user may have to hold the electronic device and tap the region to be focused on within a short period of time, which may shake the electronic device or alter the field of view of the camera. Furthermore, when the user decides to take a picture, record a video, or enable/disable camera functions, even more taps on the display panel are required, making the user difficult to hold the electronic device at a desired position with a desired angle. Therefore, finding a convenient means for focusing and image capturing has become an issue to be solved.

### SUMMARY

One embodiment of the present disclosure discloses an image-capturing system. The image-capturing system includes a first image-sensing module, a second image-sensing module, a display panel, and at least one processor. The display panel is configured to display a preview image sensed by the first image-sensing module.

The at least one processor is configured to: detect a plurality of objects in the preview image, detect a gaze region on the display panel at which a user is gazing according to gaze data acquired by the second image-sensing module, select a target from the detected objects according to the gaze region, control the first image-sensing module to perform a focusing operation with respect to the target, detect a blink mode of the user according to blink data acquired by the second image-sensing module, and perform one of camera functions with the first image-sensing module controlled to focus on the target according to the detected blink mode.

Another embodiment of the present disclosure discloses an image-capturing method. The image-capturing method includes: sensing, by a first image-sensing module, a preview image; detecting a plurality of objects in the preview image; displaying, by a display panel, the preview image; detecting a gaze region on the display panel at which a user is gazing according to gaze data acquired by a second image-sensing module; selecting a target from the detected objects in the preview image according to the gaze region; controlling the first image-sensing module to perform a focusing operation with respect to the target; detecting a blink mode of the user according to blink data acquired by the second image-sensing module; and performing one of camera functions with the first image-sensing module controlled to focus on the target according to the detected blink mode.

Since the image-capturing system and the image-capturing method allow the user to select the target that the first image-sensing module should focus on by gazing at the target shown on the display panel, and since such systems allow the user to control the image-capturing system to perform the desired camera function by blinking his or her eyes in a specific way, the user can concentrate on holding and stabilizing a camera or an electronic device while composing a photo without touching the display panel for focusing or controlling, thereby not only improving the user experience in shooting pictures/films but also reducing blurring and jittering caused by camera shake.

### BRIEF DESCRIPTION OF THE DRAWINGS

A more complete understanding of the present disclosure may be derived by referring to the detailed description and claims when considered in connection with the Figures, where like reference numbers refer to similar elements throughout the description.

FIG. 1 shows an image-capturing system according to one embodiment of the present disclosure.

FIG. 2 shows a flowchart of an image-capturing method according to one embodiment of the present disclosure.

FIG. 3 shows a preview image according to one embodiment of the present disclosure.

FIG. 4 shows the preview image in FIG. 3 with labels of objects that have been detected.

### DETAILED DESCRIPTION

The following description accompanies drawings, which are incorporated in and constitute a part of this specification, and which illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed description, and is defined by the claims.

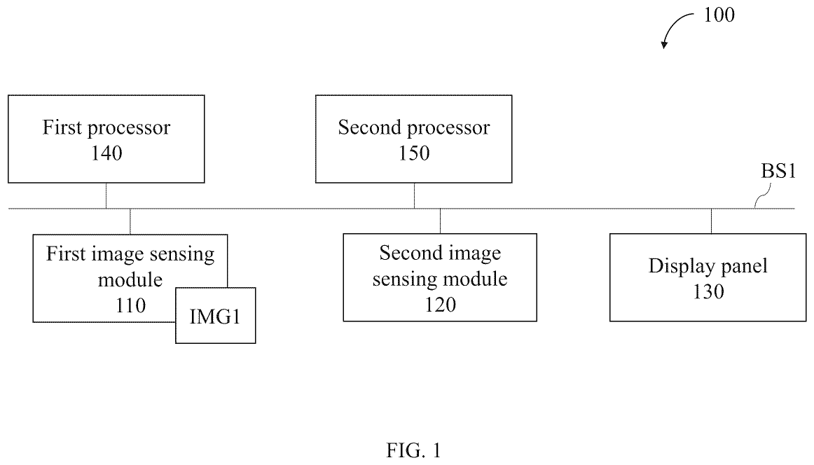

FIG. 1 shows an image-capturing system 100 according to one embodiment of the present disclosure. The image-capturing system 100 includes a first image-sensing module 110, a second image-sensing module 120, a display panel 130, a first processor 140, and a second processor 150.

In the present embodiment, the first image-sensing module 110 may be utilized to sense a scene of interest, and the display panel 130 may display an image sensed by the first image-sensing module 110 for a user's preview. In addition, the second image-sensing module 120 can be utilized to acquire the user's gaze data, thereby allowing the image-capturing system 100 to indicate a gaze region on the display panel 130 at which the user is gazing. Therefore, the image-capturing system 100 can provide a gaze-to-focus function that allows the user to select an object that the first image-sensing module 110 should focus on by gazing at the object of interest in the image shown by the display panel 130.

The second image-sensing module 120 can further be utilized to acquire the user's blink data, thereby allowing the image-capturing system 100 to detect a blink mode of the user. Consequently, the image-capturing system 100 can provide a blink-to-control function that allows the user to enable corresponding camera functions, such as taking a picture or recording a video, by blinking his or her eyes.

In some embodiments, the image-capturing system 100 may be incorporated into a mobile device. As shown in the embodiment of FIG. 1, the first processor 140 can be coupled to the first image-sensing module 110, the second image-sensing module 120, the display panel 130, and the second processor 150 through a system bus BS1. The first processor 140 may be an application processor of the mobile device, and can be utilized as a central control of the image-sensing modules 110 and 120 and the display panel 130. Also, to achieve high detecting accuracy, detection of the objects, the gaze region, and the blink mode may be performed based on different machine learning models that require large amounts of parallel computing, and thus, the second processor 150 may be a processor specialized for the parallel computing required by the machine learning models. That is, the second processor 150 may carry out the computations required for the object detection, the gaze region detection, and the blink mode detection.

In some embodiments, the second processor 150 may include a plurality of processing units, such as neural-network processing units (NPU), for the parallel computation so that a computing speed required by the machine learning models can be achieved. However, the present disclosure is not limited thereto. In some embodiments, according to the types of the required computations, the image-capturing system 100 may adopt only one processor or may adopt two or more processors. For example, the image-capturing system 100 may omit the second processor 150 and have the first processor 140 perform computations for the object detection, the gaze region detection, and the blink mode detection. Alternatively, the image-capturing system 100 may include three additional processors besides the first processor 140; each of the additional processors is responsible for the computation of the object detection, the gaze region detection, or the blink mode detection.

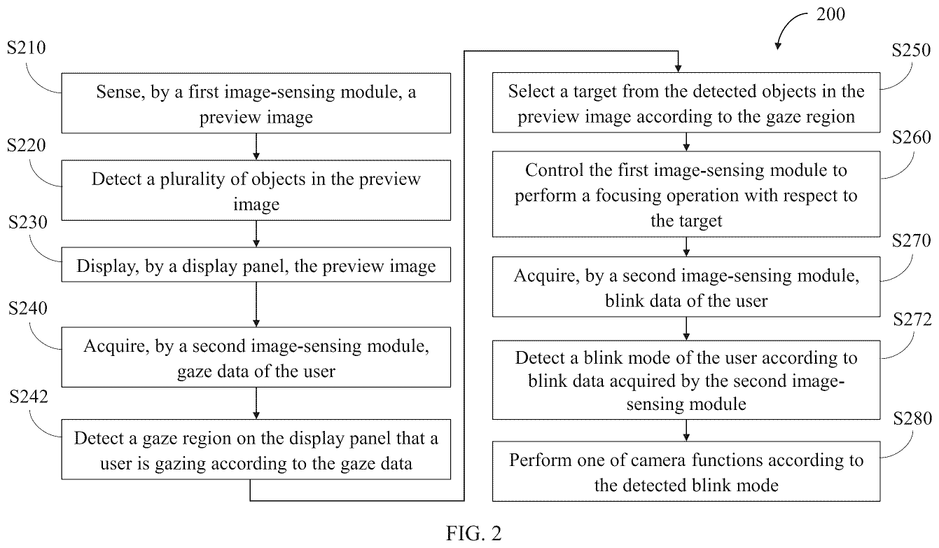

FIG. 2 shows a flowchart of an image-capturing method 200 according to one embodiment of the present disclosure. The method 200 includes steps S210 to S280 and can be applied to the image-capturing system 100.

In step S210, the first image-sensing module 110 may sense a preview image IMG1, and in step S220, the second processor 150 may detect objects in the preview image IMG1. In the present embodiment, the second processor 150 may include multiple cores and may detect the objects according to a designated machine learning model, such as a deep learning model utilizing a neural-network structure. For example, a well-known object detection algorithm, YOLO (You Only Look Once), proposed by Joseph Redmon et al. in 2015, may be adopted. However, the present disclosure is not limited thereto. In some other embodiments, other suitable models for object detection may be used, and a processor having a different structure may be adopted as the second processor 150.

In step S230, the display panel 130 can display the preview image IMG1 sensed by the first image-sensing module 110. When a user views the preview image IMG1 on the display panel 130 and gazes at an object of interest that the first image-sensing module 110 should focus on, the second image-sensing module 120 can acquire gaze data of the user in step S240. Next, in step S242, the second processor 150 can detect a gaze region at which the user is gazing according to the gaze data. In step S250, the first processor 140 can select, as a target, the object at which the user is gazing from the detected objects in the preview image IMG1 according to the detected gaze region.

In the present embodiment, in step S250, the first processor 140 may select the target after the user has looked at the gaze region for a predetermined period with the gaze region overlapping a label region of the target.

Furthermore, in some embodiments, to highlight the detected objects in the preview image IMG1 so as to assist the user in quickly locating the target, the first processor 140 or the second processor 150 may further attach labels to the detected objects, and the display panel 130 can be operable to display the preview image IMG1 with the labels of the detected objects in step S230.

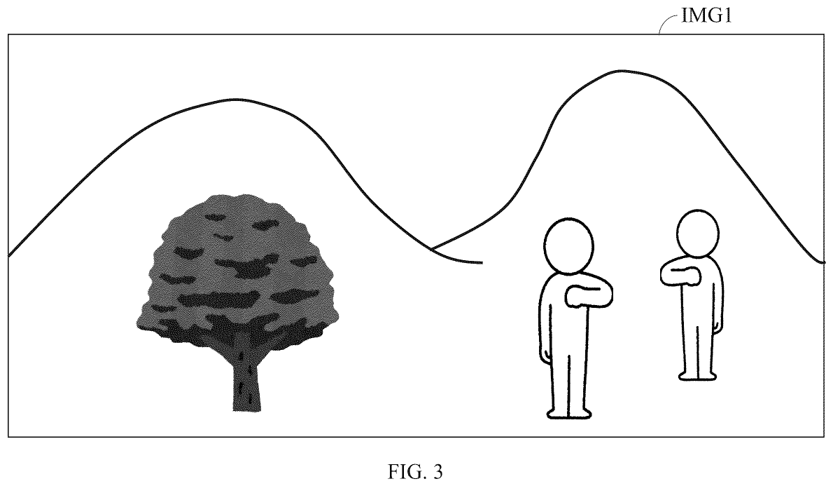

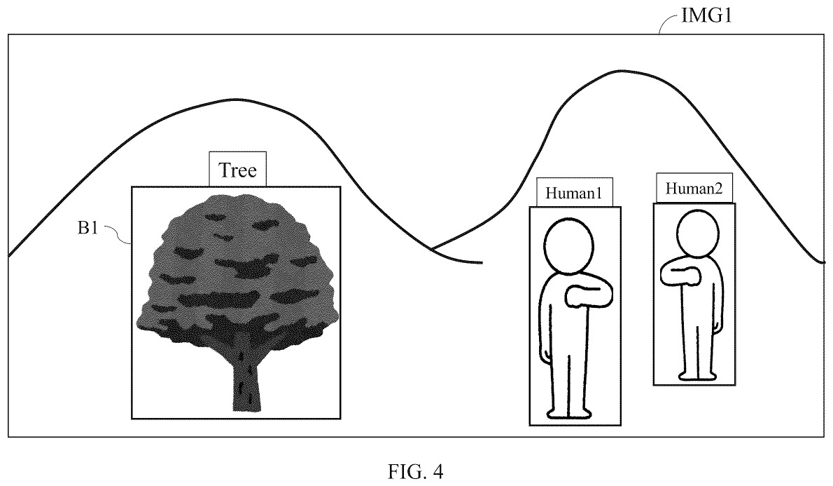

FIG. 3 shows the preview image IMG1 according to one embodiment of the present disclosure, and FIG. 4 shows the preview image IMG1 with the labels of the objects that have been detected. As shown in FIG. 4, the labels of the detected objects include the names of the objects and bounding boxes surrounding the objects. For example, in FIG. 4, a tree in the preview image IMG1 is detected, and the label of this tree includes its name, “Tree,” and a bounding box B1 surrounding the tree. Since there may be multiple objects of the same type in the preview image IMG1, the label may further include a serial number of that object. For example, in FIG. 4, the label of the first person may be “Human1,” and the label of the second person may be “Human2.” However, the present disclosure is not limited thereto. In some other embodiments, the form and the content of the label may be designed for the user's convenience so as to improve the user experience.

In addition, to inform the user that the target has been selected, the first processor 140 may further change the visual appearance of the label of the target after the target is selected so as to visually distinguish the selected target from other detected objects in the preview image IMG1.

After the target is selected, the first processor 140 can control the first image-sensing module 110 to perform a focusing operation with respect to the target in step S260. That is, the first image-sensing module 110 may adjust the position of a lens so that the target selected in step S250 appears sharp in an image. When the first image-sensing module 110 is thus controlled to focus on the target, the image-capturing system 100 is ready to perform camera functions, such as taking pictures or recording videos.

In some embodiments, the first processor 140 or the second processor 150 may continuously track the movement of the target, so that the first image-sensing module 110 can be controlled to keep the target in focus while the camera function is running.

Furthermore, in the present embodiment, the user may convey his or her request by blinking his or her eyes, and the image-capturing system 100 can detect the user's blink mode and determine which of the camera functions is to be performed according to the user's blink mode. For example, in step S270, the second image-sensing module 120 can acquire the blink data of the user, and then, in step S272, the second processor 150 can detect the blink mode of the user according to the blink data.

In some embodiments, the second image-sensing module 120 may capture a series of snapshots of the user that include the user's face or eyes as blink data, and the second processor 150 may ascertain the position of the user's each eye and detect the movement of the eyelids so as to detect the blink mode of the user. However, the present disclosure is not limited thereto. In some embodiments, other types of algorithms may be adopted for blink detection.

In the present embodiment, the image-capturing system 100 may be incorporated into a mobile device, such as a smartphone or a tablet. If the display panel 130 is installed on the front side of the mobile device, then the first image-sensing module 110 may be installed on the rear side while the second image-sensing module 120 may be installed on the front side and adjacent to or under the display panel 130. Therefore, when a user uses the first image-sensing module 110 to take a picture or record a video, the second image-sensing module 120 may be used to sense the user's eyes for acquiring the gaze data and blink data.

In some embodiments, the first image-sensing module 110 and the second image-sensing module 120 may be cameras that include charge-coupled device (CCD) sensors or complementary metal-oxide semiconductor (CMOS) sensors for sensing light reflected from the objects in the scene. Also, in some embodiments, the second image-sensing module 120 may include a high frame rate camera to detect the blink mode accurately. However, the present disclosure is not limited thereto.

After the blink mode is detected, in step S280, the first processor 160 can further perform a corresponding camera function accordingly with the first image-sensing module 110 controlled to focus on the target. For example, if the blink mode indicates that the user's first eye blinks, then the first processor 160 may perform a first camera function, such as taking a picture. If the blink mode indicates that the user's second eye blinks, then the first processor 160 may perform a second camera function, such as recording a video. In some embodiments, the user's first eye can be the user's left eye, and the user's second eye can be the user's right eye.

The image-capturing system 100 provides a blink-to-control function that allows the user to control the image-capturing system 100 by blinking one of his or her eyes to convey his or her request for performing the corresponding camera function.

Therefore, the user can hold the mobile device firmly and keep the image-capturing system 100 stable without touching the screen or any button.

Furthermore, in some other embodiments, the image-capturing system 100 may be configured to perform camera functions according to other blink modes.

For example, if the second processor 150 detects that the blink mode indicates that both eyes of the user blink, then the first processor 140 may perform the first camera function. If the second processor 150 detects that the blink mode indicates that only one of the user's eyes blinks, then the first processor 140 may perform the second camera function. In some embodiments, the first camera function may refer to taking a picture, and the second camera function may refer to recording a video. However, the present disclosure is not limited thereto.

In addition, in some other embodiments, the image-capturing system 100 may further detect other parameters, such as the number of times the user blinks, to identify some other blink modes. For example, the second processor 150 may measure the blink duration of the user and count the total number of times that the user blinks within a predetermined period according to the blink data acquired by the second image-sensing module 120. In this case, the first processor 140 may be configured to perform one of the camera functions according to the blink duration and the total number of times that the user blinks within the predetermined period.

For example, if the blink duration is longer than a predetermined time, that is, if the user closes his or her eyes for an extended time, then the second processor 150 may recognize the blink mode as a first mode, and the first processor 140 may perform the first camera function accordingly. However, if the blink duration is not exceeding the predetermined time, then the second processor 150 may recognize the blink mode as a second mode, and the first processor 140 may perform the second camera function accordingly.

Alternatively, if the frequency of the blinks is greater than a predetermined number, for example, 2 times within a predetermined period, then the second processor 150 may recognize the blink mode as a first mode, and the first processor 140 may perform the first camera function accordingly. If the frequency of the blinks is fewer than or equal to the predetermined number within the predetermined period, then the second processor 150 may recognize the blink mode as a second mode, and the first processor 140 may perform the second camera function accordingly.

In some embodiments, the image-capturing system 100 may define more than two blink modes so as to allow the user to control the image-capturing system 100 to perform even more types of camera functions. Since the image-capturing system 100 can provide both a gaze-to-focus function and the blink-to-control function, the image-capturing system 100 allows the user to concentrate on holding the mobile device and composing photos, thereby improving the user experience in taking pictures and recording videos.

In addition, to improve the data security of the image-capturing system 100, the first processor 140 or the second processor 150 may further perform a face recognition operation to authenticate the user before proceeding to perform the camera functions. That is, the user can use the image-capturing system 100 to perform camera functions only if the user is authenticated by the face recognition operation. In some embodiments, the face recognition operation may be performed before the gaze detection or the blink mode detection, which uses the gaze data or the blink data acquired by the second image-sensing module 120.

In summary, the image-capturing system and the image-capturing method provided by the embodiments of the present disclosure allow the user to select a target that the first image-sensing module should focus on by gazing at the target shown on the display panel, and allow the user to control the image-capturing system to perform the desired camera function by blinking his or her eyes in a specific way. Therefore, the user can concentrate on holding and stabilizing the camera or the electronic device while composing a photo without touching the display panel for focusing or controlling, thereby not only improving the user experience in shooting pictures/films but also reducing blurring and jittering caused by camera shake.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An image-capturing system, comprising:
a first image-sensing module;
a second image-sensing module;
a display panel configured to display a preview image sensed by the first image-sensing module; and
at least one processor configured to:
detect a plurality of objects in the preview image,
detect a gaze region on the display panel at which a user is gazing according to gaze data acquired by the second image-sensing module,
select a target from the detected objects according to the gaze region,
control the first image-sensing module to perform a focusing operation with respect to the target,
detect a blink mode of the user according to blink data acquired by the second image-sensing module, and
perform one of camera functions with the first image-sensing module controlled to focus on the target according to the detected blink mode.

2. The image-capturing system of claim 1, wherein the camera functions comprise taking pictures and recording videos, and the at least one processor is configured to:
take a picture when the blink mode indicates that the user's first eye has blinked; and
record a video when the blink mode indicates that the user's second eye has blinked.

3. The image-capturing system of claim 1, wherein the at least one processor is configured to:
perform a first camera function when the blink mode indicates that both eyes of the user have blinked; and
perform a second camera function when the blink mode indicates that only one eye of the user has blinked.

4. The image-capturing system of claim 1, wherein:
the at least one processor is further configured to detect the blink mode of the user according to the blink data by measuring a blink duration of the user and counting a total number of times that the user blinks within a predetermined period; and
the at least one processor decides to perform one of the camera functions according to the blink duration and the total number of times that the user blinks within the predetermined period.

5. The image-capturing system of claim 1, wherein the at least one processor comprises:
a first processor configured to select the target and control the first image-sensing module to perform the focusing operation; and
a second processor configured to detect the objects in the preview image based on a first machine learning model and to detect the blink mode of the user based on a second machine learning model.

6. The image-capturing system of claim 1, wherein the at least one processor is further configured to attach labels to the detected objects, and the display panel is operable to display the preview image with the labels of the detected objects.

7. The image-capturing system of claim 6, wherein the at least one processor selects the target after the user has looked at the gaze region for a predetermined period when the gaze region overlaps a label region of the target.

8. The image-capturing system of claim 6, wherein the at least one processor is further configured to change a visual appearance of the label of the target after the target is selected so as to visually distinguish the target from other detected objects in the preview image.

9. The image-capturing system of claim 1, wherein the at least one processor is further configured to track movement of the target, thereby controlling the first image-sensing module to keep the target in focus while performing one of the camera functions.

10. The image-capturing system of claim 1, wherein the at least one processor is further configured to perform a face recognition operation to authenticate the user, and to proceed to detect the gaze region at which the user is gazing when the user is authenticated.

11. An image-capturing method, comprising:
sensing, by a first image-sensing module, a preview image;
detecting a plurality of objects in the preview image;
displaying, by a display panel, the preview image;
detecting a gaze region on the display panel at which a user is gazing according to gaze data acquired by a second image-sensing module;
selecting a target from the detected objects in the preview image according to the gaze region;
controlling the first image-sensing module to perform a focusing operation with respect to the target;
detecting a blink mode of the user according to blink data acquired by the second image-sensing module; and
performing one of camera functions with the first image-sensing module controlled to focus on the target according to the detected blink mode.

12. The method of claim 11, wherein the camera functions comprise taking pictures and recording videos, and the step of performing one of the camera functions comprises:
deciding to take a picture when the blink mode indicates that the user's first eye has blinked; and
deciding to record a video when the blink mode indicates that the user's second eye has blinked.

13. The method of claim 11, wherein the step of performing one of the camera functions comprises:
deciding to perform a first camera function when the blink mode indicates that both eyes of the user have blinked; and
deciding to perform a second camera function when the blink mode indicates that only one eye of the user has blinked.

14. The method of claim 11, wherein the step of detecting the blink mode comprises:
measuring a blink duration of the user according to the blink data; and
counting a total number of times that the user blinks within a predetermined period;
wherein one of the camera functions is performed according to the blink duration and the total number of times that the user blinks within the predetermined period.

15. The method of claim 11, wherein:
the step of detecting the objects in the preview image is performed based on a first machine learning model; and
the step of detecting the blink mode of the user is performed based on a second machine learning model.

16. The method of claim 11, further comprising:
attaching labels to the detected objects; and
displaying the preview image with the labels of the detected objects.

17. The method of claim 16, wherein the step of selecting the target from the detected objects in the preview image comprises deciding the target after the user has looked at the gaze region for a predetermined period when the gaze region overlaps a label region of the target.

18. The method of claim 16, further comprising:
changing a visual appearance of the label of the target after the target is selected so as to visually distinguish the target from other detected objects in the preview image.

19. The method of claim 11, further comprising:
tracking movement of the target, thereby controlling the first image-sensing module to keep the target in focus while performing one of the camera functions.

20. The method of claim 11, further comprising:
performing a face recognition operation to authenticate the user;
wherein the step of detecting the gaze region at which the user is gazing is allowed to be performed when the user is authenticated.
